(19) United States
(12) Patent Application Publication
(10) Pub. No.: US 2025/0316409 A1
(43) Pub. Date: Oct. 9, 2025

(54) STRUCTURE AND METHOD FOR MAGNETIC CORE WITH STACKED MAGNETICALLY ANISOTROPIC LAYERS

(71) Applicant: GlobalFoundries U.S. Inc., Malta, NY (US)

(72) Inventors: Patrick Rohlfs, Dresden (DE); Clarissa Cyrilla Prawoto, Dresden (DE)

(21) Appl. No.: 18/628,886

(22) Filed: Apr. 8, 2024

(51) Int. Cl. H01F 1/03; H01F 27/24; H01F 41/02

(52) U.S. Cl. CPC H01F 1/0306; H01F 27/24; H01F 41/02

(57) ABSTRACT

Embodiments of the disclosure provide a structure and method for a magnetic core with stacked magnetically anisotropic layers. A structure of the disclosure provides a magnetic core including a plurality of stacked magnetically anisotropic layers. Each of the plurality of stacked magnetically anisotropic layers has a hard axis angularly offset from an adjacent hard axis of an adjacent magnetically anisotropic layer. An inductor coil is on the magnetic core.

### BACKGROUND

The disclosure relates to inductor structures and the forming of such structures.

Integration of soft magnetic materials (i.e., materials that can become magnetized or demagnetized at relatively low energy levels) into integrated circuits (ICs) has benefited device performance, particularly in the case of inductors, transformers, and/or other components which operate using magnetic fields. Components featuring soft magnetic materials, however, suffer from limitations in maximum current achievable in the device due to the saturation of magnetic flux produced from magnetic fields within the soft magnetic material(s). That is, the current may not increase beyond a particular maximum when the magnetic field strength in the inductor is too high, causing the inductor to be functionally indistinguishable from other implementations relying on air gaps and/or other open space as a medium for magnetic fields. Hybrid device structures combining soft magnetic materials with empty space may offer higher saturation currents but undesirably limit magnetic flux density.

### SUMMARY

The illustrative aspects of the present disclosure are designed to solve the problems herein described and/or other problems not discussed.

Embodiments of the disclosure provide a structure including: a magnetic core including a plurality of stacked magnetically anisotropic layers, wherein each of the plurality of stacked magnetically anisotropic layers has a hard axis angularly offset from an adjacent hard axis of an adjacent magnetically anisotropic layer; and an inductor coil on the magnetic core.

Other embodiments of the disclosure provide a structure including: a magnetic core including a plurality of stacked magnetically anisotropic layers from a lowermost magnetic layer to an uppermost magnetic layer, wherein each of the plurality of stacked magnetically anisotropic layers has a hard axis angularly offset from an adjacent hard axis of an adjacent magnetic layer, wherein a lowermost hard axis orientation in the plurality of stacked magnetically anisotropic layers is diametrically opposed to an uppermost hard axis orientation in the plurality of stacked magnetically anisotropic layers; and an inductor coil on the magnetic core.

Additional embodiments of the disclosure provide a method including: forming a magnetic core including a plurality of stacked magnetically anisotropic layers, wherein each of the plurality of stacked magnetically anisotropic layers has a hard axis angularly offset from an adjacent hard axis of an adjacent magnetic layer; and forming an inductor coil on the magnetic core.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a cross-sectional view of a magnetic core with stacked magnetically anisotropic layers according to embodiments of the disclosure.

FIG. 2 shows a plan view of a magnetic core with stacked magnetically anisotropic layers according to embodiments of the disclosure.

FIG. 3 shows a perspective view of a structure including a magnetic core and an example inductor coil according to embodiments of the disclosure.

FIG. 4 shows a perspective view of a structure including a different example inductor coil according to further embodiments of the disclosure.

FIG. 5 shows a plan view of a structure and process to form one magnetically anisotropic layer of a magnetic core according to embodiments of the disclosure.

FIG. 6 shows a side view of a structure and process to form the magnetically anisotropic layer according to embodiments of the disclosure.

FIG. 7 shows a plan view of a structure and process to form another magnetically anisotropic layer of a magnetic core according to embodiments of the disclosure.

FIG. 8 shows an illustrative flow diagram of methods to form a magnetic core and inductor coil according to embodiments of the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

In the following description, reference is made to the accompanying drawings that form a part thereof, and in which is shown by way of illustration specific illustrative embodiments in which the present teachings may be practiced. These embodiments are described in sufficient detail to enable those skilled in the art to practice the present teachings, and it is to be understood that other embodiments may be used and that changes may be made without departing from the scope of the present teachings. The following description is, therefore, merely illustrative.

It will be understood that when an element such as a layer, region, or substrate is referred to as being “on” or “over” another element, it may be directly on the other element or intervening elements may also be present. In contrast, when an element is referred to as being “directly on” or “directly over” another element, there may be no intervening elements present. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

Reference in the specification to “one embodiment” or “an embodiment” of the present disclosure, as well as other variations thereof, means that a particular feature, structure, characteristic, and so forth described in connection with the embodiment is included in at least one embodiment of the present disclosure. Thus, the phrases “in one embodiment” or “in an embodiment,” as well as any other variations appearing in various places throughout the specification are not necessarily all referring to the same embodiment. It is to be appreciated that the use of any of the following “/,” “and/or,” and “at least one of,” for example, in the cases of “A/B,” “A and/or B” and “at least one of A and B,” is intended to encompass the selection of the first listed option (a) only, or the selection of the second listed option (B) only, or the selection of both options (A and B). As a further example, in the cases of “A, B, and/or C” and “at least one of A, B, and C,” such phrasing is intended to encompass the first listed option (A) only, or the selection of the second listed option (B) only, or the selection of the third listed option (C) only, or the selection of the first and the second listed options (A and B), or the selection of the first and third listed options (A and C) only, or the selection of the second and third listed options (B and C) only, or the selection of all three options (A and B and C). This may be extended, as readily apparent by one of ordinary skill in the art, for as many items listed.

Embodiments of the disclosure provide a structure and method for a magnetic core with stacked magnetically anisotropic layers. A structure of the disclosure provides a magnetic core including a plurality of stacked magnetically anisotropic layers. Each of the plurality of stacked magnetically anisotropic layers has a hard axis angularly offset from an adjacent hard axis of an adjacent magnetically anisotropic layer. An inductor coil is on the magnetic core. Magnetic cores according to structures and methods disclosed herein differ from conventional magnetic cores by providing a different hard axis orientation in each layer. During operation, these differing orientations will prevent current from reaching saturation levels at less than a desired magnitude. Thus, structures and methods described herein allow inductors with magnetic core materials to be implemented in a wider array of situations than would otherwise be possible.

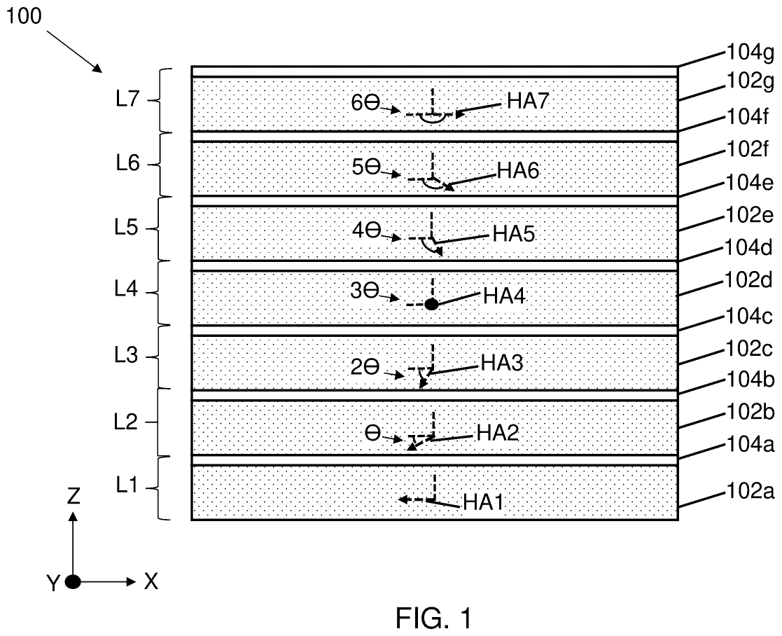

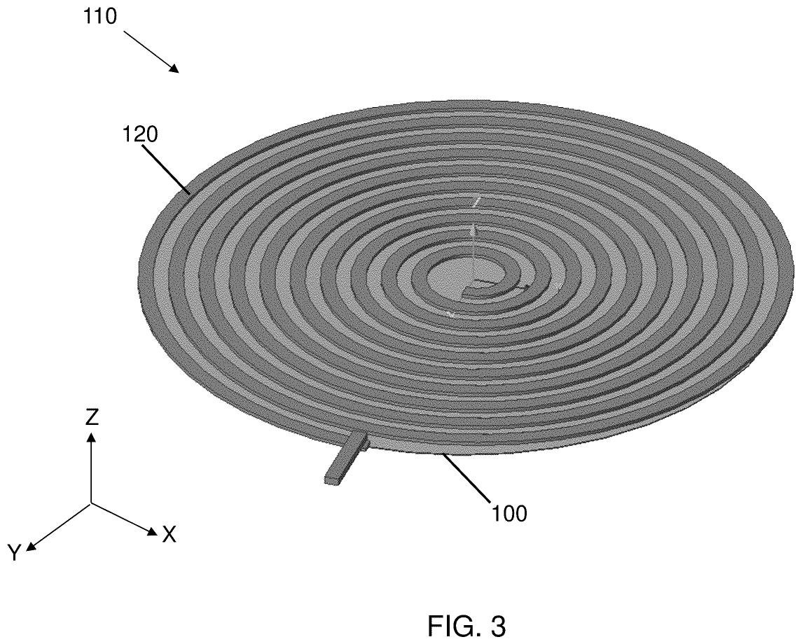

Referring to FIG. 1, a magnetic core 100 for a structure 110 (FIG. 3) according to embodiments of the disclosure is shown. Magnetic core 100 may be suitable for use in an inductor (e.g., to increase the strength of a magnetic field in a spiral inductor coil 120 (FIG. 3) and thereby increase the inductance, as discussed in greater detail below). Various features of magnetic core 100 are, initially, discussed in detail for better explanation of their interaction with spiral inductor coil 120 and function within structure 110. Magnetic core 100 includes several stacked magnetically anisotropic layers (simply “layers” hereafter). In the example of FIG. 1, seven layers (L1, L2, L3, L4, L5, L6, L7) are shown. Any number of stacked layers is possible, and seven layers are shown to provide an example. Each layer L1, L2, L3, L4, L5, L6, L7 may include multiple components, e.g., a magnetic layer 102 and an insulator layer 104 on magnetic layer 102. In this arrangement, each insulator layer 104 may provide a boundary of non-magnetic material vertically separating each magnetic layer 102 from each other. For sake of references, magnetic layer 102 and insulator layer 104 of each layer L1, L2, L3, L4, L5, L6, L7 are indicated with respective reference letters (a, b, c, d, e, f, and g, respectively) but may have similar or identical compositions except where noted herein.

Each layer L1, L2, L3, L4, L5, L6, L7 of magnetic core 100, and more particularly each magnetic layer 102a, 102b, 102c, 102d, 102e, 102f, 102g thereof, may include a magnetically anisotropic material. The term “magnetically anisotropic” refers to any magnetized material with magnetic properties that vary relative to directional orientation within the material. Magnetically anisotropic materials thus differ from magnetically isotropic materials in that magnetically isotropic materials have unvarying magnetic properties (e.g., magnetic strength and orientation, known as “magnetic moment”) with respect to direction. The ability to magnetize a magnetically anisotropic material thus differs with respect to the directional orientation of a magnetic field. The “easy axis” of a magnetically anisotropic material refers to an axis having a directional orientation in parallel with the direction in which it is easiest to magnetize the material. Conversely, the “hard axis” of a magnetically anisotropic material refers to an axis having a directional orientation in parallel with the direction in which it is hardest to magnetize the material.

In magnetic core 100 according to embodiments of the disclosure, each successive layer L1, L2, L3, L4, L5, L6, L7 has a different hard axis from its adjacent layer such that magnetic fields from a coil about magnetic core 100 will saturate at higher currents, e.g., due to the different magnetic moment orientations in each layer. In conventional magnetic cores, magnetically isotropic materials and/or materials having similar or uniform hard axes are used, thus causing saturation to occur at lower magnitudes of current. Each magnetic layer 102 thus may include any currently known or later developed magnetically anisotropic material, e.g., Cobalt Zirconium Tantalum (CZT), Iron Cobalt (FeCo) alloys, and/or other metallic materials, alloys, etc., having magnetically anisotropic properties. For ease of manufacture and/or for better magnetic separation between each magnetic layer 102, each insulator layer 104 may include an oxide, nitride, or other insulator together with the same material or similar materials as magnetic layer 102. For instance, where magnetic layers 102 include CZT, insulator layers 104 may include Cobalt Zirconium Tantalum Oxide (CZTO), aluminum nitride (AlN), or similar composite materials.

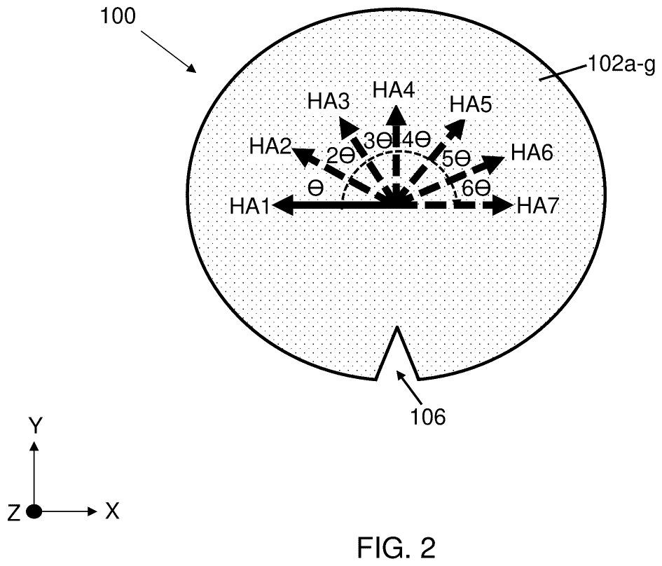

Referring now to FIGS. 1 and 2 together, further features of magnetic core 100 are discussed. FIG. 2 provides a plan view of magnetic core 100 and one magnetic layer (e.g., magnetic layer 102a) thereof. Other magnetic layers 102b, 102c, 102d, 102e, 102f, 102g are superimposed on magnetic layer 102a and magnetic features thereof (e.g., hard axis orientations) are shown in dashed lines. An initial layer 138 may include a notch 106 (FIG. 2 only) for orienting each magnetic layer 102 in a processing chamber and/or other apparatus during manufacture as discussed herein.

In magnetic core 100, each stacked layer L1, L2, L3, L4, L5, L6, L7 may have a corresponding hard axis, i.e., hard axes HA1, HA2, HA3, HA4, HA5, HA6, HA7 for each layer. Each hard axis HA1, HA2, HA3, HA4, HA5, HA6, HA7 may have a different orientation from that of its adjacent layer. The hard axis orientation of an anisotropic material may arise from its material properties and/or underlying method(s) of manufacture. As an example, layer L1 may have a hard axis HA1 oriented substantially in parallel with, and in opposition to, the positive X-axis orientation. Each successive layer in magnetic core 100 may have a hard axis orientation that is angularly offset from the orientation of its adjacent layers by a uniform angular offset Θ. Angular offset Θ may have any predetermined value, e.g., thirty degrees in the example of FIG. 1. Angular offset Θ may be smaller than thirty degrees in the case where more layers are present or may be larger than thirty degrees in the case where fewer layers are present. In addition, none of layers L1, L2, L3, L4, L5, L6, L7 may have a hard axis with a Z-direction component; each hard axis HA1, HA2, HA3, HA4, HA5, HA6, HA7 may be within the X-Y plane. In FIG. 1, the positive Y direction extends out of the plane of the page.

Magnetic layer 102a of layer L1 may have hard axis HA1 with no Y direction component and oriented substantially in opposition to the positive X direction. Magnetic layer 102b of layer L2 may have hard axis HA2 with no Z direction component but oriented thirty degrees away (i.e., angular offset Θ) from the negative X direction. The direction of HA2 appears diagonal in FIG. 1 to indicate that it extends partially out of the page. Magnetic layer 102c of layer L3 may have hard axis HA3 with no Z direction component, but oriented sixty degrees away (i.e., two times angular offset Θ or “2Θ”) from the negative X direction. Magnetic layer 102d may have hard axis HA4 that extends in the positive Y direction and has no X component or Z component, e.g., by being oriented ninety degrees away (i.e., three times angular offset Θ or (“3Θ”) from the negative X direction.

In a similar manner, magnetic layers 102e, 102f may have hard axes HA5, HA6 with no Z direction components but oriented at one-hundred and twenty and one-hundred and fifty degrees away, respectively, from the negative X direction (i.e., four times angular offset Θ (“4Θ”) and five times angular offset Θ (“5Θ”)). Magnetic layer 102g may have hard axis HA7 with no Y component or Z component and oriented in the positive X direction, i.e., it is oriented at one-hundred and eighty degrees or six times angular offset Θ (“6Θ”) from the negative X direction. Thus, magnetic layers 102a, 102g may have hard axes HA1, HA7 that are diametrically opposed to each other within plane X-Y. Regardless of the number of magnetic layers 102 in magnetic core 100, two layers (e.g., lowermost and uppermost magnetic layers) may have diametrically opposed hard axes, with any layers therebetween having intermediate orientations that are uniformly angularly offset from the hard axis orientation of any adjacent layers. In some cases, e.g., the example shown in FIGS. 1 and 2, one magnetic layer (e.g., magnetic layer 102d) may have a hard axis orientation that is orthogonal to the diametrically opposed hard axis orientations. FIG. 1 depicts hard axis HA4 of magnetic layer 102d as being orthogonal to the orientation of hard axes HA1 of magnetic layer 102a and HA7 of magnetic layer 102g. Any number of layers may be included in magnetic core 100 while retaining these orientations, where applicable.

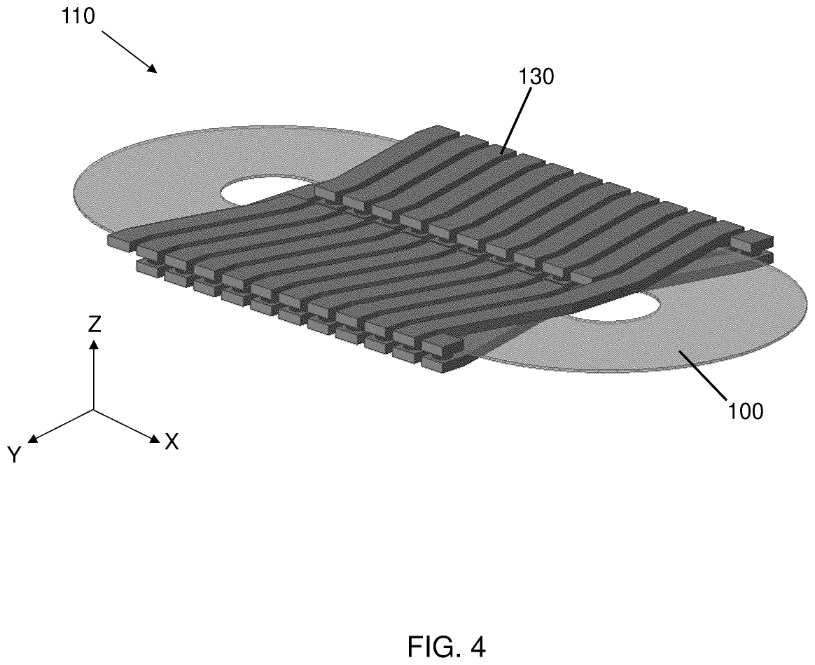

Referring to FIG. 3, magnetic core 100 may be included within a structure 110 having a spiral inductor coil 120 on magnetic core 100. In this context, spiral inductor coil 120 being “on” magnetic core 100 refers to spiral inductor coil 120 being in electromagnetic communication with magnetic core 100, e.g., by being over, beneath, and/or around magnetic core 100 and the various layers thereof. Although individual layers L1, L2, L3, L4, L5, L6, L7 and their components are not visible in FIGS. 3 and 4, this is solely due to their size relative to spiral inductor coil 120.

In a first example, inductor coil 120 may include a loop of conductive material (e.g., copper (Cu), aluminum (Al), and/or other materials suitable for use as conductive wires) configured to create a magnetic field to oppose increasing and decreasing electric currents within the span of structure 110. Spiral inductor coil 120 may be subdivided into a plurality of individual windings (also known as “turns”) that together define a conductive loop within structure 110. Although not specifically shown in FIG. 3, some portions of spiral inductor coil 120 are located below magnetic core 100. At least a portion of spiral inductor coil 120 may extend vertically through magnetic core 100 (e.g., at or near a center of magnetic core 100) to interconnect similarly or identically shaped spiral segments of spiral inductor coil 120 on each surface of magnetic core 100.

Electric currents passing through spiral inductor coil 120, due to the spiral shape of spiral inductor coil 120, will produce magnetic fields within magnetic core 100 due to Faraday's Law of Induction. These magnetic fields within magnetic core 100, in turn, oppose further accumulation of current within structure 110 (e.g., within spiral inductor coil 120) when the current therethrough is not in a steady state operating mode (i.e., transient operation). Embodiments of the disclosure differ from conventional inductors, e.g., by having multiple layers of magnetically anisotropic material within magnetic core 100, thus altering the magnetic field strength induced within magnetic core 100 from spiral inductor coil 120. Among other things, this change in magnetic field strength will be different relative to position over magnetic core 100 and thus prevent the electric current within structure 110 from saturating at less than a desired magnitude.

Referring to FIG. 4, structure 110 additionally or alternatively may include a toroidal inductor coil 130 on magnetic core 100. Here, magnetic core 100 may be in a rounded shape having a hollow interior but otherwise may be similar or identical to other implementations discussed herein. Thus, magnetic core 100 in this configuration still may include multiple stacked magnetically anisotropic layers, each having magnetic layer 102 and insulator layer 104, and each having a hard axis angularly offset from an adjacent hard axis of an adjacent magnetically anisotropic layer. Toroidal magnetic core 130 may surround different portions of magnetic core 100 and may include vertical interconnections located circumferentially outside of, and within, the rounded shape of magnetic core 100.

Toroidal inductor coil 130, despite being shaped differently from spiral inductor coil 120, may be operationally similar or identical. That is, electric currents within toroidal inductor coil 130 having changing magnitudes may produce magnetic fields within magnetic core 100 via Faraday's Law of Induction. These magnetic fields within magnetic core 100 oppose further accumulation of current within toroidal inductor coil 130 of structure 110. As with other implementations of structure 110, the varying hard axis orientations within magnetic core 100 will prevent the electric current within toroidal inductor coil 130 from saturating at less than a desired magnitude, e.g., by providing slightly weaker magnetic fields in a variety of directions within magnetic core 100. It is emphasized that in addition to spiral inductor coil 120 (FIG. 3) and toroidal inductor coil 130 (FIG. 4), structure 110 and magnetic core 100 thereof may be implemented with any currently known or later developed inductor coil shape.

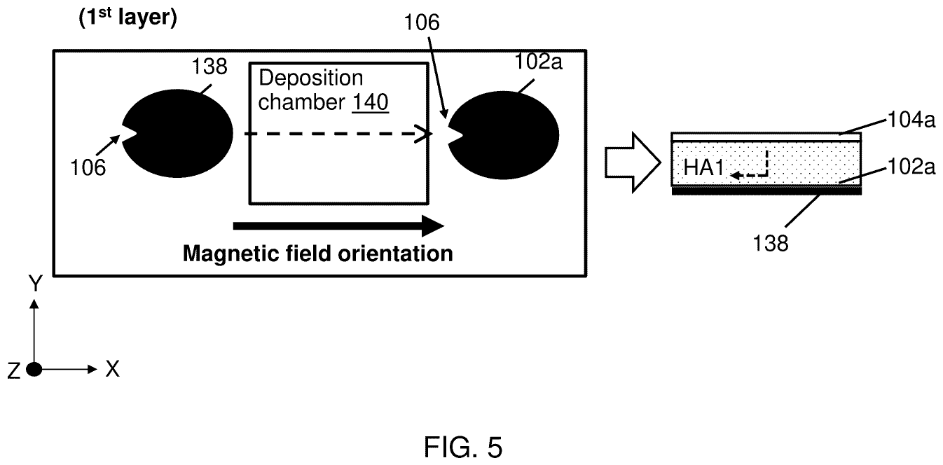

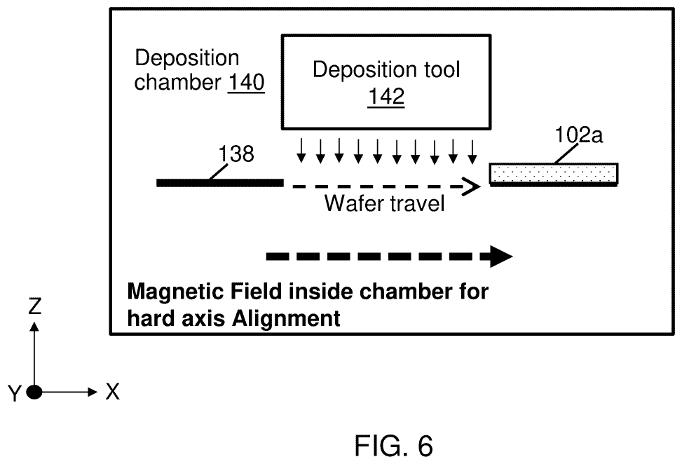

Turning to FIGS. 5 and 6, embodiments of the disclosure provide methods to form embodiments of magnetic core 100 and structure 110 discussed herein. FIG. 5 depicts a plan view and FIG. 6 depicts a side view of an example tool for processing of successive magnetic layers 102. In various embodiments, methods of the disclosure may include forming magnetic core 100 including stacked magnetic layers 102, each having a magnetically anisotropic layer and a hard axis that is angularly offset from the hard axis of an adjacent magnetic layer 102. As discussed herein, each magnetic layer 102 may have a similar or identical composition and may differ simply by having a different hard axis orientation. Methods of the disclosure provide processing tools and/or techniques to provide the different hard axis orientations in each layer. FIG. 5 schematically depicts an example of one initial layer 138 passing through a deposition chamber 140. Within deposition chamber 140, materials are formed on initial layer 138 via a deposition tool 142 (FIG. 6 only, e.g., a sputtering system for depositing of desired materials in a particular area of space, as indicated with downward arrows) to create magnetic layer 102a. Deposition tool 142 may include any currently known or later developed processing chamber for depositing layers of material (e.g., CZT and/or CZTO as discussed herein) on initial layer 138 in a sealed or otherwise controlled environment (i.e., deposition chamber 140). Initial layer 138 may be a wafer of placeholder material e.g., silicon and/or other semiconductor layers providing space for magnetic material(s) to be formed thereon.

Deposition chamber 140 may have a magnetic field therein, and the magnetic field may have a particular orientation during the deposition of materials on initial layer 138 within deposition chamber 140. As indicated by notch 106 within initial layer 138, initial layer 138 may have a particular orientation as it enters deposition chamber 140. As magnetic and insulative material(s) (e.g., CZT and/or CZTO) are formed on initial layer 138 to create magnetic layer 102a, the magnetic field orientation within deposition chamber 140 will produce a hard axis orientation HA1 in a direction derived from the magnetic field orientation. In the example of FIG. 5, hard axis HA1 has an orientation diametrically opposed to the magnetic field orientation within deposition chamber 140. The relationship between magnetic field orientation in deposition chamber 140 and resulting hard axis orientation may depend on the magnetically anisotropic material(s) deposited.

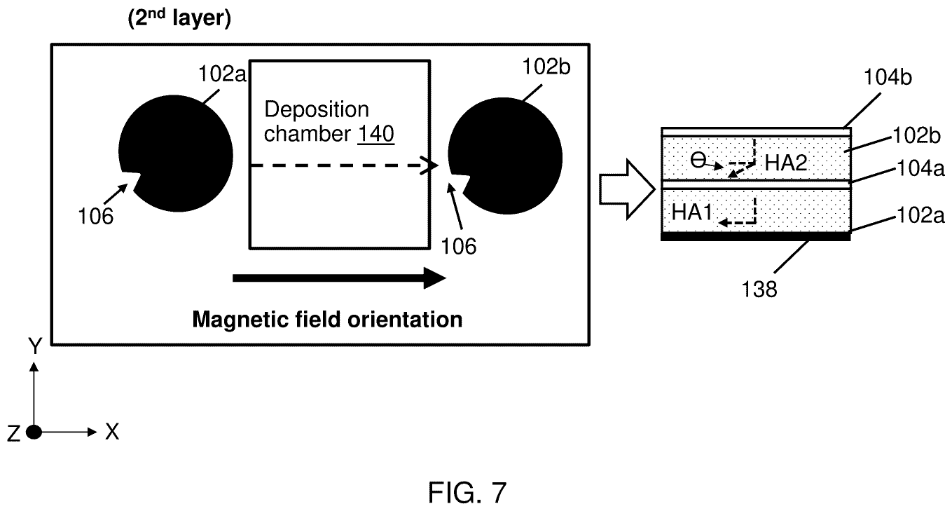

FIG. 7 depicts further processing to form additional magnetic layers, e.g., magnetic layer 102b as shown. After forming magnetic layer 102b, further processing may include rotating magnetic layer 102a by a predetermined amount, e.g., by the same angle as angular offset Θ, after layers 102a, 104a have been formed. The magnetic field orientation within deposition chamber 140 may remain without modification, and another magnetic layer 102b and insulator layer 104b may be formed on layers 102a, 104a. The continued presence of a magnetic field in deposition chamber 140, but different orientation of material(s) passing therethrough, causes magnetic layer 102b to have a different hard axis orientation HA2 from hard axis orientation HA1 despite being processed identically to magnetic layer 102a. By continuing to form additional magnetic layers 102 and insulator layers 104 with different physical orientation, each set of layers may have a distinct hard axis orientation and may differ by a predetermined number of degrees. Thus, deposition chamber 140 and deposition tool 142 (FIG. 6) are operable to produce magnetic core 100 (FIGS. 1-4) having a distinct hard axis orientation in each magnetic layer 102 thereof.

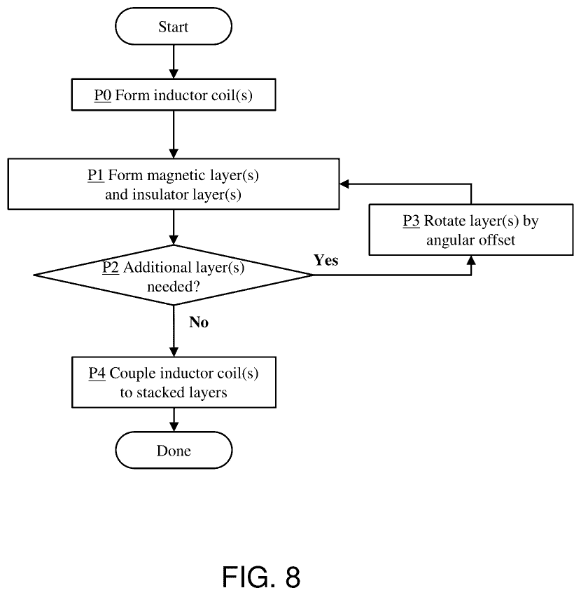

Referring briefly to the illustrative flow diagram FIG. 8, together with FIGS. 5-7, methods of the disclosure may be implemented to provide an inductor with magnetic core 100 (FIGS. 1-4) and an inductor coil (e.g., inductor coil(s) 120 (FIG. 3), 130 (FIG. 4)) thereon. Process P0 may include forming one or more inductor coils, e.g., spiral inductor(s) 120 (FIG. 3) and/or toroidal inductor(s) (FIG. 4) to be used with a magnetic core as discussed herein. Process P1 may include forming magnetic layer 102 and insulator layer 104 on initial layer 138. In the first implementation of process P1, magnetic layer 102 and insulator layer 104 may be the first materials formed on initial layer 138 and may have a particular orientation as discussed herein. Process P2 may include, e.g., determining whether additional layers should be formed to provide a stack. As discussed herein, methods of the disclosure include forming multiple layers each having a respective hard axis orientation. Where at least one additional layer needs to be formed (e.g., “Yes” at process P2), the method may continue by implementing process P3 of rotating any previously formed layer(s) 102, 104, 138 by a predetermined amount. The rotating of such layers is indicated by comparing the location of notch 106 in FIG. 5 with the location of notch 106 in FIG. 7.

After the rotating in process P3, further processing may include repeating process P1 of forming additional magnetic layers 102 and insulator layers 104 with a different hard axis orientation from any previously formed layers. Process P2 then may repeat to determine whether yet more additional layers will be formed. In various embodiments, the number of layers may be selected such that two layers in magnetic core 100 have diametrically opposed hard axis orientations, and/or another layer in magnetic core 100 may have a hard axis orientation that is orthogonal to the orientation of the hard axis for another layer. In the case where still more layers will be formed in the stack, processes P3 and P1 may be re-implemented as many times as desired. Once a stack of layers 102, 104 is formed in a desired number (i.e., “No” at process P2), processing may continue to process P4 of coupling one or more inductor coils (e.g., spiral inductor 120 or toroidal inductor coil 130) to magnetic core 100 to provide structure 110. In some implementations, processes P0 and P4 may be implemented together, e.g., by forming inductor coil(s) 120, 130 on magnetic core 100 to provide structure 110. After structure 110 is formed, the method may conclude (“Done”), and the same tools (e.g., deposition chamber 140, deposition tool 142) may be used to form a different inductor.

Embodiments of the disclosure may provide several technical advantages, examples of which are discussed herein. As compared to conventional inductor structures having magnetic cores, the presence of multiple layers each having a different hard axis orientation offers improved electrical performance by avoiding current saturation at less than desired current magnitudes. In turn, embodiments of the disclosure offer circuit fabricators the option to use a wider variety of inductor shapes and sizes with the ability to achieve any higher values of inductance offered by such inductor geometries. Furthermore, as discussed herein relative to the forming of inductors, conventional deposition chambers and/or deposition tools may be used in the case where previously formed layers are rotated by desired amount before new layers are formed thereon. The turning of previously formed layers optionally may be implemented by minor modifications, e.g., providing a turnable chuck and shieldings to existing deposition equipment.

The method and structure as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher-level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a center processor.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A structure comprising:
a magnetic core including a plurality of stacked magnetically anisotropic layers, wherein each of the plurality of stacked magnetically anisotropic layers has a hard axis angularly offset from an adjacent hard axis of an adjacent magnetically anisotropic layer; and
an inductor coil on the magnetic core.

2. The structure of claim 1, wherein the hard axis of each of the plurality of stacked magnetically anisotropic layers is uniformly offset from the hard axis of an adjacent magnetic layer.

3. The structure of claim 1, wherein a first hard axis orientation of a lowermost layer in the plurality of stacked magnetically anisotropic layers is diametrically opposed to a second hard axis orientation of an uppermost layer in the plurality of stacked magnetically anisotropic layers.

4. The structure of claim 3, wherein a third hard axis orientation of an intermediate layer in the plurality of stacked magnetically anisotropic layers is orthogonal to the first hard axis orientation and the second hard axis orientation.

5. The structure of claim 1, wherein each of the plurality of stacked magnetically anisotropic layers includes a magnetic layer and an insulator layer on the magnetic layer.

6. The structure of claim 5, wherein the magnetic layer includes Cobalt Zirconium Tantalum (CZT) and the insulator layer includes Cobalt Zirconium Tantalum Oxide (CZTO).

7. The structure of claim 1, wherein the inductor coil is one of a spiral inductor or a toroidal inductor.

8. A structure comprising:
a magnetic core including a plurality of stacked magnetically anisotropic layers from a lowermost magnetic layer to an uppermost magnetic layer, wherein each of the plurality of stacked magnetically anisotropic layers has a hard axis angularly offset from an adjacent hard axis of an adjacent magnetic layer, wherein a lowermost hard axis orientation in the plurality of stacked magnetically anisotropic layers is diametrically opposed to an uppermost hard axis orientation in the plurality of stacked magnetically anisotropic layers; and
an inductor coil on the magnetic core.

9. The structure of claim 8, wherein an intermediate hard axis orientation of an intermediate layer in the plurality of stacked magnetically anisotropic layers is orthogonal to the uppermost hard axis orientation and the lowermost hard axis orientation.

10. The structure of claim 8, wherein each of the plurality of stacked magnetically anisotropic layers includes a magnetic layer and an insulator layer on the magnetic layer.

11. The structure of claim 10, wherein the magnetic layer includes Cobalt Zirconium Tantalum (CZT) and the insulator layer includes Cobalt Zirconium Tantalum Oxide (CZTO).

12. The structure of claim 8, wherein the inductor coil is a spiral inductor.

13. The structure of claim 8, wherein the inductor coil is a toroidal inductor.

14. A method comprising:
forming a magnetic core including a plurality of stacked magnetically anisotropic layers, wherein each of the plurality of stacked magnetically anisotropic layers has a hard axis angularly offset from an adjacent hard axis of an adjacent magnetic layer; and
forming an inductor coil on the magnetic core.

15. The method of claim 14, wherein forming the plurality of stacked magnetically anisotropic layers includes rotating each layer such that the hard axis of each of the plurality of stacked magnetically anisotropic layers is uniformly offset from the hard axis of an adjacent magnetic layer.

16. The method of claim 14, wherein forming the plurality of stacked magnetically anisotropic layers includes rotating each layer such that a first hard axis orientation of a lowermost layer in the plurality of stacked magnetically anisotropic layers is diametrically opposed to a second hard axis orientation of an uppermost layer in the plurality of stacked magnetically anisotropic layers.

17. The method of claim 16, wherein rotating each layer further causes a third hard axis orientation of an intermediate layer in the plurality of stacked magnetically anisotropic layers to be orthogonal to the first hard axis orientation and the second hard axis orientation.

18. The method of claim 14, wherein forming each of the plurality of stacked magnetically anisotropic layers includes forming a magnetic layer and forming an insulator layer on the magnetic layer.

19. The method of claim 18, wherein the magnetic layer includes copper zirconium tantalum (CZT) and the insulator layer includes copper zirconium tantalum oxide (CZTO).

20. The method of claim 14, wherein forming the inductor coil includes forming one of a spiral inductor or a toroidal inductor.
